(19) United States
(12) Patent Application Publication
(10) Pub. No.: US 2009/0074642 A1
(43) Pub. Date: Mar. 19, 2009

(54) SPRAY DRYER ABSORBER AND RELATED PROCESSES

(76) Inventor: Mikhail Maramchik, Fairlawn, OH (US)

Correspondence Address: BABCOCK & WILCOX POWER GENERATION GROUP, INC., PATENT DEPARTMENT, 20 SOUTH VAN BUREN AVENUE, BARBERTON, OH, 44203, US

(21) Appl. No.: 11/854,795

(22) Filed: Sep. 13, 2007

(51) Int. Cl. B01D 47/00; B01J 8/18

(52) U.S. Cl. 423/215.5; 422/140; 422/198; 423/210

(57) ABSTRACT

A spray dryer absorber (SDA) system used to reduce the concentration of at least one acid compound in a gas utilizes low or no alkali-containing particulate compounds to prevent cementing during operation. The low or no-alkali-containing compounds may be supplied from external sources and/or from a particulate collection device located downstream of the SDA.

### FIELD AND BACKGROUND OF THE INVENTION

1. Field of the Invention

The present invention relates, in general, to the field of environmental pollution control equipment used to remove pollutants from gases produced during the combustion of fossil fuels and, more particularly, to spray dryer absorbers used to remove acid gas compounds from such gases. The gases may be produced by industrial processes as well as combustion processes used in the production of steam for electric power generation.

2. Description of the Related Art

Electric power generating plants and other industries that combust fossil fuels (e.g., coal, oil, petroleum coke, and/or waste materials) create various contaminants that include, among other things, acid gases (such as sulfur oxides) and other unwanted and/or undesirable chemical compounds in the flue gas produced during combustion.

One of the most common methods for reducing sulfur oxides in flue gases is through a spray drying chemical absorption process, also known as dry scrubbing, wherein an aqueous alkaline solution or slurry is finely atomized (via, for example, mechanical, dual fluid, or rotary atomizers), and sprayed into the hot flue gas to remove the contaminants. For a better understanding of spray drying chemical absorption processes, or dry scrubbing, the reader is referred to STEAM its generation and use, 41^{st} Ed., Kitto and Stultz, eds., Copyright © 2005, The Babcock & Wilcox Company, particularly Chapter 35, pages 35-12 through 35-18, the text of which is hereby incorporated by reference as though fully set forth herein.

Spray dry absorption (SDA) reflects the primary reaction mechanisms involved in the process: drying alkaline reagent slurry atomized into fine droplets in the hot flue gas stream and absorption of SO₂ and other acid gases from the gas stream. The process is also called semi-dry scrubbing to distinguish it from injection of a dry solid reagent into the flue gas.

In a typical boiler installation arrangement, the SDA is positioned before the dust collector. Flue gases leaving the last heat trap (typically, air heater) at a temperature of 250° F. to 350° F. (121° C. to 177° C.) enter the spray chamber where the reagent slurry is sprayed into the gas stream, cooling the gas to 150° F. to 170° F. (66° C. to 77° C.). An electrostatic precipitator (ESP) or fabric filter (baghouse) can be used to collect the reagent, flyash and reaction products. Baghouses are the dominant selection for U.S. SDA installations (over 90%) and provide for lower reagent consumption to achieve similar overall system SO₂ emissions reductions.

SO₂ absorption takes place primarily while the water is evaporating and the flue gas is adiabatically cooled by the spray. Reagent stoichiometry and approach temperature are the two primary variables that control the scrubber's SO₂ removal efficiency. The stoichiometry is the molar ratio of the reagent consumed to either the inlet SO₂ or the quantity of SO₂ removed in the process. Depending upon available reagent and acid gas content in the flue gases, the stoichiometry can vary widely; e.g., from about 1 to more than 10. The difference between the temperature of the flue gas leaving the dry scrubber and the adiabatic saturation temperature is known as the approach temperature. Flue gas saturation temperatures are typically in the range of 115° F. to 125° F. (46° C. to 52° C.) for low moisture bituminous coals and 125° F. to 135° F. (52° C. to 57° C.) for high moisture subbituminous coals or lignites. The optimal conditions for SO₂ absorption must be balanced with practical drying considerations.

The predominant reagent used in dry scrubbers is lime slurry produced by slaking a high-calcium pebble lime. The slaking process can use a ball mill or a simple detention slaker. SDA systems that use only lime slurry as the reagent are known as single pass systems. Some of the lime remains unreacted following an initial pass through the spray chamber and is potentially available for further SO₂ collection. Solids collected in the ESP or baghouse may be mixed with water and reinjected in the spray chamber of the SDA along with the SDA reagent.

If the fuel sulfur content is low and/or the fuel contains enough alkalis, as is known to be the case for certain types of coal and oil shale, the ash particles themselves could serve as a source of reagent in the SDA. Typically, the alkali in fuel that can produce sufficient sulfur capture is calcium carbonate (CaCO₃).

Another example of ash particles being capable of serving as a reagent source in the SDA for capturing SO₂ is the ash from a circulating fluidized bed (CFB) boiler. This type of boiler typically utilizes limestone, which has as its predominant component calcium carbonate, fed to the furnace for in-furnace capture of SO₂ generated in the combustion process.

Whether part of the fuel or limestone, calcium carbonate in the furnace undergoes calcination, i.e. releases gaseous carbon dioxide and yields a solid calcium oxide, CaO, also known as lime:

CaCO₃→CaO+CO₂

The CaO reacts with SO₂ in the furnace gases thus producing calcium sulfate:

CaO+SO₂+1/2O₂→CaSO₄

Calcium sulfate generated in the reaction covers the surface of the particle with a shell impenetrable for SO₂ thus stopping the reaction and rendering any CaO in its core unutilized.

In order to react with SO₂ in the SDA, the ash particles containing alkalis have to be reactivated. This can be done by wetting them with water spray. In such a case, instead of spraying lime slurry, water will be sprayed into the flue gas in the SDA.

A typical SDA process is as follows. The flue gas enters a spray dryer absorber where the gas stream is cooled by the reagent slurry or water spray. The mixture then passes on to the baghouse for removal of particulate before entering the induced draft fan and passing up the stack. If lime slurry is used as a reagent, pebble lime (CaO) is mixed with water at a controlled rate to maintain a high slaking temperature that helps generate fine hydrated lime (Ca(OH)₂) particles with high surface area in the hydrated lime slurry (18 to 25% solids). A portion of the flyash, unreacted lime and reaction products collected in the baghouse may be mixed with water and returned to the SDA as a high solids (35 to 45% typical) slurry. The remaining solids are directed to a storage silo for byproduct utilization or disposal. The fresh lime and recycle slurries (if any) are combined just prior to the atomizer(s) to enable fast response to changes in gas flow, inlet SO₂ concentrations, and SO₂ emissions as well as to minimize the potential for scaling.

SO₂ absorption in an SDA occurs in the individual slurry droplets or particles of wetted ash. Most of the reactions take place in the aqueous phase; the SO₂ and the alkaline constituents dissolve into the liquid phase where ionic reactions produce relatively insoluble products. The reaction path can be described as follows:

SO₂(g)⇄SO₂(aq) (a)

Ca(OH)₂(s)→Ca⁺²+2OH⁻ (b)

SO₂(aq)+H₂O⇄HSO₃⁻+H⁺ (c)

SO₂(aq)+OH⁻⇄HSO₃⁻ (d)

OH⁻+H⁺⇄H₂O (e)

HSO₃⁻+OH⁻⇄SO₃⁻²+H₂O (f)

Ca⁺²+SO₃⁻²+1/2H₂O→CaSO₃.1/2H₂O(s) (g)

The above reactions generally describe activity that takes place as heat transfer from the flue gas to the slurry droplet or wetted ash particle causes evaporation of the slurry droplet or the water from the surface of the wetted ash particle. Rapid SO₂ absorption occurs when liquid water is present. The drying rate can be slowed down to prolong this period of efficient SO₂ removal by adding deliquescent salts to the reagent feed slurry. Salts such as calcium chloride also increase the equilibrium moisture content of the end product. However, since the use of these additives alters the drying performance of the system, the operating conditions must be adjusted (generally increasing the approach temperature) to provide for good long-term operability of the SDA and the ash handling system. Ammonia injection upstream of a dry scrubber also increases SO₂ removal performance. SO₂ absorption continues at a slower rate by reaction with the solids in the downstream particulate collector.

An SDA/baghouse combination also provides efficient control of HCl, HF and SO₃ emissions by the summary reactions of:

Ca(OH)₂+2HCl→CaCl₂+2H₂O (1)

Ca(OH)₂+2HF→CaF₂+2H₂O (2)

Ca(OH)₂+SO₃→CaSO₄+H₂O (3)

Proper accounting of the reagent consumption must include these side reactions, in addition to the SO₂ removed in the process.

Spray dryer absorbers (SDAs) can be a separate structure, or they can be an integrated part of the flue that precedes one or more particle collection devices, such as one or more baghouses or electrostatic precipitators. In either case the one or more SDAs should provide sufficient residence time for droplets of the lime slurry and/or water (sprayed for humidifying ash particles) to dry completely. Failure to do so results in the growth of cemented ash deposits on the walls of the one or more SDAs rendering them inoperable. Possible malfunctioning of the reagent distribution components, such as a plugging of the nozzles, can lead to a drastic increase in the coarseness of the reagent droplets. In such a case, even a very large SDA is not capable of accomplishing complete drying. Thus, the long-term reliability of such an SDA is compromised.

Therefore, there is a need in the art for a device and/or method for improving reliability of SDA operation while allowing reducing its size.

### SUMMARY OF THE INVENTION

In the present invention, as will be explained in detail below, a low or no alkali-containing granular material is provided to one or more SDAs to improve reliability and/or compactness of the SDA.

The present invention generally relates to utilizing a spray dryer absorber downstream of a source of one or more acidic gases. In one embodiment, the present invention relates to improved spray dryer absorbers that are utilized in combination with a source of one or more acidic gases, such as a circulating fluidized bed (CFB) boiler.

In one embodiment, the present invention relates to a system for reducing the tendency for cementing in a spray dryer absorber. The system comprises at least one source of at least one gas, such at least one gas containing at least one acid compound, the concentration of which in the at least one gas has to be reduced. Also provided is at least one spray dryer absorber using at least one alkali-containing reagent for reacting with the at least one acid compound. In addition, at least one means for introducing at least one particulate compound into the at least one gas in combination with the at least one alkali-containing reagent, wherein the at least one particulate compound has a low or no alkali content, is provided.

In another embodiment, the present invention relates to a method of operating a system with a spray dryer absorber to reduce the tendency for cementing in the spray dryer absorber comprising the steps of: (A) providing at least one gas stream from at least one source, wherein the at least one gas stream contains at least one acid compound, which content has to be reduced; (B) providing a spray dryer absorber designed to receive the at least one gas stream from the at least one gas source, the spray dryer absorber using at least one alkali-containing reagent for reacting with the at least one acid compound; (C) providing at least one means for introducing at least one particulate compound into the at least one gas stream, wherein the at least one particulate compound has a low or no alkali content, to reduce the tendency for cementing in the spray dryer absorber during operation.

The various features of novelty which characterize the invention are pointed out with particularity in the claims annexed to and forming a part of this disclosure. For a better understanding of the invention, its operating advantages and the specific benefits attained by its uses, reference is made to the accompanying drawings and descriptive matter in which preferred embodiments of the invention are illustrated.

### BRIEF DESCRIPTION OF THE DRAWINGS

FIG. 1 is a simplified schematic illustration of a system according to the present invention when the alkali-containing reagent is injected into the gas stream from a source external to the gas stream, e.g. when the alkali-containing reagent is lime slurry; and

FIG. 2 is a simplified schematic illustration of a system according to the present invention when the alkali-containing reagent is introduced from the same source as the gas stream, e.g. when the alkali-containing reagent is fly ash from the combustor.

### DESCRIPTION OF THE PREFERRED EMBODIMENT

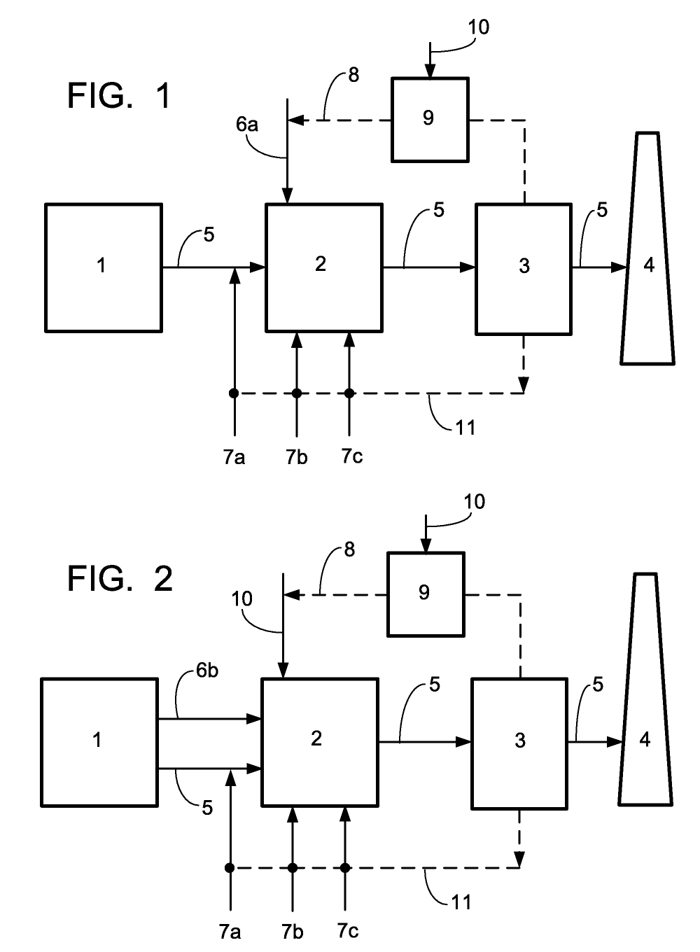

Referring to the drawings generally, wherein like reference numerals designate the same or functionally similar elements throughout the several drawings, and to FIG. 1 in particular, the present invention relates to a spray dryer absorber (SDA) method and apparatus used to reduce the concentration of at least one acid compound contained in a gas. The SDA is provided downstream of a source of the gas.

In one embodiment, shown in FIG. 1, the system includes a source 1 of a gas containing at least one acid compound, the concentration of which in the gas has to be reduced; an SDA 2; a particulate collection device 3, e.g., fabric filter (baghouse) or electrostatic precipitator (ESP), and a stack 4. The gas source 1 can be a chemical reactor, a combustor, a boiler, etc. A gas stream 5 from the gas source 1 travels through the SDA 2, the particulate collection device 3 and on to the stack 4, from where it is released to the atmosphere. An alkali-containing reagent 6a, such as lime slurry, from an external source is injected into the gas stream 5 in the SDA 2 for reacting with the at least one acid compound in the gas stream 5. A low or no alkali-containing particulate compound, such as fly ash from another combustor, or sand, is injected into the gas stream 5 through injecting means which may be provided at one or more locations. A first location 7a may be provided upstream of the SDA 2. A second location 7b may be provided directly into the SDA 2 simultaneously with the injection of the alkali-containing reagent 6a. A third location 7c may be provided directly into the SDA 2, but downstream of the location where injection of the alkali-containing reagent 6a occurs. It is understood that any combination of locations 7a, 7b or 7c of the means for injecting the low or no alkali-containing particulate compound may be used in the practice of the present invention.

A portion of the particulate matter comprising fly ash, unreacted lime and reaction products collected in the particulate collection device 3 may be mixed in a hydrator 9 with water 10 for reactivating the unreacted lime and returning it to the SDA 2 via line 8 for introduction along with the alkali-containing reagent 6a. If the alkali content in the material collected in the particulate collection device 3 is low enough not to cause cementing when wetted, it can be recycled via line 11 and injected into the gas stream 5 alone or in combination with the low or no alkali-containing particulate compound through any combination of the injecting means locations 7a, 7b and 7c. The material may be recycled “as-is” from the particulate collection device 3 along the recycle line 11. The purpose of the recycle, as well as that of injecting the low or no alkali-containing particulate compound, is to use these particles to dilute the alkali-containing reagent for reducing its cementing potential. This improves reliability of the SDA and/or allows reducing its size.

In another embodiment, shown in FIG. 2, the system includes a source 1 of a gas containing at least one acid compound, which content in the gas has to be reduced; a spray dryer absorber (SDA) 2, a particulate collection device 3 and a stack 4. The gas source 1 can again be a chemical reactor, a combustor, a boiler, etc. The gas stream 5 from the gas source 1 travels through the SDA 2, the particulate collection device 3 and to the stack 4, from where it is released to the atmosphere. An alkali-containing reagent 6b originates from the same source as the gas stream 5; e.g., it may be an alkali-containing fly ash from the combustor. (This may be the case when firing a fuel with low sulfur content and/or high alkali content, as in certain types of coal and oil shale. Another example of ash particles being capable of serving as a reagent in the SDA for reducing acid compounds in the flue gas is ash from a fluidized bed boiler, in particular from a circulating fluidized bed (CFB) boiler. This type of boiler typically utilizes limestone, which has as its predominant component calcium carbonate, fed to the furnace for in-furnace capture of SO₂ generated in the combustion process.) Water 10 is sprayed into the gas stream 5 in the SDA 2 for reactivating the alkali-containing fly ash, which then reacts with the at least one acid compound in the gas stream 5.

A low or no alkali-containing particulate compound, such as fly ash from another combustor, is injected into the gas stream 5 through the injecting means 7a upstream of the SDA 2 or the injecting means 7b in the SDA 2 simultaneously with injecting water 10 or the injecting means 7c in the SDA 2 downstream of injecting water 10 or any combination of the means 7a, 7b and 7c. A portion of the fly ash collected in the particulate collection device 3 may be mixed in the hydrator 9 with water 10 for reactivating the unreacted lime in the ash and returned to the SDA 2 via line 8 for introduction into the SDA along with the water 10. If the alkali content in the material collected in the particulate collection device 3 is low enough not to cause cementing when wetted, it can be recycled via line 11 and injected into the gas stream 5 alone or in combination with the low or no alkali-containing particulate compound through any combination of the injecting means 7a, 7b and 7c. The material may be recycled “as-is” from the particulate collection device 3 along the recycle line 11. The purpose of the recycle, as well as that of injecting the low or no alkali-containing particulate compound, is to use these particles to dilute the alkali-containing reagent for reducing its cementing potential. This improves reliability of the SDA and/or allows reducing its size.

As is noted above, the at least one low or no alkali-containing particulate compound can be injected upstream of the point, or points, where the alkali-containing reagent 6a or water 10 is injected into the SDA 2 (means 7a in FIG. 1 and FIG. 2, accordingly). This is a preferred location for injecting the low or no alkali-containing particulate compound since it improves the mixing of the compound with the reagent thus reduces the potential for cementing in the SDA 2. However, if required due to equipment constraints, the particulate compound can be injected concurrently with (means 7b) or downstream of (means 7c) the point, or points, at which the alkali-containing reagent 6a or water 10 is injected into the SDA 2.

Another aspect of the present invention relates to a method of operating a system with a spray dryer absorber comprising the steps of: (A) providing at least one gas stream from at least one source, wherein the at least one gas stream contains at least one acid compound, which content has to be reduced; (B) providing a spray dryer absorber designed to receive the at least one gas stream from the at least one gas source, the spray dryer absorber using at least one alkali-containing reagent for reacting with the at least one acid compound; (C) providing at least one means for introducing at least one particulate compound into the at least one gas stream, wherein the at least one particulate compound has a low or no alkali content; and (D) providing at least one particulate collection device collecting particulate matter in the at least one gas stream prior to its leaving the system.

In general, the acid compounds may be SO₂ and other sulfur compounds, such as SO₃ and H₂SO₄, as well as non-sulfur compounds, such as hydrogen chloride (HCl). The alkali-containing reagent may be calcium-based, sodium-based, etc.

In addition to cost reduction benefits, reducing the size of a spray dryer absorber (SDA) opens up the potential for using SDAs in spatially confined applications where larger equipment would be difficult or impossible to use. For example, the size reduction can be beneficial when retrofitting existing units.

Although the invention has been described in detail with particular reference to certain embodiments detailed herein, other embodiments can achieve the same results. For example, the present invention may be applied in new construction involving SDAs, or to the repair, replacement, and modification or retrofitting of existing SDAs. Variations and modifications of the present invention will be obvious to those skilled in the art and the present invention is intended to cover in the appended claims all such modifications and equivalents covered by the scope of the following claims.

I claim:

1. A system for reducing the tendency for cementing in a spray dryer absorber, comprising:
at least one source of at least one gas, such at least one gas containing at least one acid compound, the concentration of which in the at least one gas has to be reduced;
at least one spray dryer absorber for receiving the at least one gas and using at least one alkali-containing reagent for reacting with the at least one acid compound; and
at least one means for introducing at least one particulate compound into the at least one gas in combination with the at least one alkali-containing reagent, wherein the at least one particulate compound has a low or no alkali content, to prevent cementing in the spray dryer absorber during operation.

2. The system of claim 1, wherein the at least one gas comprises gas from a combustion process.

3. The system of claim 2, wherein the combustion process is conducted in a fluidized bed boiler.

4. The system of claim 3, wherein the combustion process is conducted in a circulating fluidized bed boiler.

5. The system of claim 1, wherein the alkali-containing reagent comprises lime slurry, fly ash, or a mixture thereof.

6. The system of claim 1, comprising at least one particulate collection device for collecting particulate matter from the at least one gas prior to its leaving the system, and wherein the at least one particulate compound comprises ash recycled as-is from the at least one particulate collection device.

7. A method of operating a system with a spray dryer absorber to reduce the tendency for cementing in the spray dryer absorber, comprising the steps of:
(A) providing at least one gas stream from at least one source, wherein the at least one gas stream contains at least one acid compound, the concentration of which in the at least one gas stream has to be reduced;
(B) providing a spray dryer absorber designed to receive the at least one gas stream from the at least one gas source, the spray dryer absorber using at least one alkali-containing reagent for reacting with the at least one acid compound; and
(C) providing at least one means for introducing at least one particulate compound into the at least one gas stream, wherein the at least one particulate compound has a low or no alkali content, to reduce the tendency for cementing in the spray dryer absorber during operation.

8. The method of claim 7, wherein Step (C) occurs prior to the at least one alkali-containing reagent starting reacting with the at least one acid compound.

9. The method of claim 7, wherein Step (C) occurs simultaneously with the at least one alkali-containing reagent starting reacting with the at least one acid compound.

10. The method of claim 7, wherein Step (C) occurs after the at least one alkali-containing reagent starting reacting with the at least one acid compound.

11. The method of claim 7, wherein the at least one gas stream comprises gas from a combustion process.

12. The method of claim 7, wherein the combustion process is conducted in a fluidized bed boiler.

13. The method of claim 12, wherein the combustion process is conducted in a circulating fluidized bed boiler.

14. The method of claim 7, wherein the alkali-containing reagent comprises lime slurry, fly ash, or a mixture thereof.

15. The method of claim 7, comprising the further step of:
(D) providing at least one particulate collection device for collecting the at least one particulate compound from the at least one gas stream prior to its leaving the system, and wherein the at least one particulate compound comprises ash recycled as-is from the at least one particulate collection device.
